(19) United States
(12) Patent Application Publication
(10) Pub. No.: US 2023/0025294 A1
(43) Pub. Date: Jan. 26, 2023

(54) COMPOSITE PANEL ELEMENT FOR GUIDING LIGHT

(71) Applicant: Temicon GmbH, Dortmund (DE)

(72) Inventor: Oliver Humbach, Dortmund (DE)

(21) Appl. No.: 17/788,036

(22) PCT Filed: Dec. 18, 2020
(86) PCT No.: PCT/EP2020/087231

§ 371 Date: Jun. 22, 2022

(30) Foreign Application Priority Data
Dec. 23, 2019 (DE) 10 2019 135 712.8

(51) Int. Cl. E06B 3/67

(52) U.S. Cl. CPC E06B 3/6715

(57) ABSTRACT

A composite panel element for guiding light, a window having the same, and a method for producing the same. To provide a composite panel element with good light guiding properties and being optically transparent and homogeneous, the composite panel element for guiding light has a first panel element with a first microstructure on a first inner surface and a second panel element with a second microstructure on a second inner surface. The first and the second microstructure have respective depressions/elevations. The panel elements are arranged such that the first and the second inner surface are facing one another, and the first and second microstructure are arranged such that internal micro-cavities are formed between the microstructures. The first and second microstructure have respective planar-contact adhesion sections for force-lockingly securing the panel elements to one another and/or corresponding latching sections for form-lockingly and/or force-lockingly securing the panel elements to one another.

The invention relates to a composite panel element for guiding light, a window having a composite panel element of this type and a method for producing a composite panel element of this type.

Composite panel elements for guiding light are known in many and varied configurations from the prior aft. For example, WO 2013/012865 A2 discloses substrates having layers for guiding light, which can be formed as window panes. In order to achieve a light guidance of this type, the composite panel elements frequently have air-filled structures in their interior, to enable total reflection.

There is a clear need for high-quality panel elements for guiding light: the electrical lighting of buildings makes a considerable contribution to the global consumption of energy. Depending on the area, 10-20% of the energy of a commercial building is used for lighting. A more efficient utilization of daylight is therefore of great interest and leads to significant energy savings. In addition, natural daylight promotes people's wellbeing, health and productivity.

However, the disadvantage of numerous composite panel elements known from the prior art is that these are not completely transparent due to the air-filled structures they contain, but rather they are merely diffusely transparent. In addition, an imprecise construction of the composite panel elements frequently leads to a deviating optical behavior in various areas of the composite panel element. Finally, the composite panel elements of the prior art are frequently formed from multiple layers which are bonded to one another, as a result of which the adhesive itself and fluctuations in the thickness of the adhesive layer, furthermore, cause undesirable optical disturbances.

It might be an object to provide a composite panel element with good light guiding properties and being, in particular, optically transparent and homogeneous, and which can be advantageously used in windows of buildings and which can be manufactured in a simple manner.

The object is achieved according to the invention by a composite panel element for guiding light according to claim 1, a window having a composite panel element of this type according to claim 14, and a method for producing a composite panel element of this type according to claim 15. Advantageous developments of the invention are indicated in the dependent claims.

The composite panel element according to the invention for guiding light has a first panel element with a first microstructure on a first inner surface and a second panel element with a second microstructure on a second inner surface, wherein the first and the second microstructure have respective depressions and/or elevations. Furthermore, the panel elements in the composite panel element are arranged in relation to one another such that the first and the second inner surface are facing one another, and the first and second microstructure are arranged so that they engage with one another such that internal micro-cavities are formed between the microstructures. The first and second microstructure have respective planar-contact adhesion sections for force-lockingly securing the panel elements to one another and/or mutually corresponding latching sections for form-lockingly and/or force-lockingly securing the panel elements to one another.

Furthermore, the invention relates to a window having a window pane and a composite panel element according to the invention applied thereon.

In the method according to the invention for producing a composite panel element for guiding light, at first a first panel element with a first microstructure comprising elevations and depressions on a first inner surface and a second panel element with a second microstructure comprising elevations and depressions on a second inner surface are provided , wherein the panel elements are subsequently arranged in relation to one another such that the first and the second inner surface are facing one another, and the first and second microstructure are arranged so that they engage with one another such that internal micro-cavities are formed between the microstructures, wherein an form-fitting and/or force-fitting of the panel elements to one another by means of planar-contact adhesion sections in each case of the first and second microstructure and/or by means of corresponding latching sections is achieved.

The inventors have recognized that it is, in particular, advantageous for deflecting daylight into the depth of the rooms in window facades, for example in skylights, to provide micro-cavities, in particular, micro-lamellae, in the interior of a composite panel element, which reflect the incident light totally as long as the conditions for total reflection are observed, so that the light deflection is therefore substantially based on loss-free total reflection. Particularly long and/or precise micro-cavities can be produced by meshing the first and second microstructure. In particular, gaps having a very large aspect ratio (ratio of width to height) can be created in an advantageous manner, which can no longer be realized in manufacturing terms with the conventional microstructuring of surfaces. Finally, in the case of the composite panel element according to the invention, due to the form-fitting and/or force-fitting of the panel elements to one another, a disturbance of the micro-cavities by further means or methods for securing is avoided or respectively the influence thereof is reduced in a simple and advantageous manner, wherein in particular no adhesive for securing the panel elements to one another is necessary. Especially when used in glass facades and windows, complete transparency is, in addition, particularly advantageous and of particular importance.

The composite panel element according to the invention at first is formed from a composite of at least two parts, the panel elements, wherein the composite panel element is preferably formed all-over from the two panel elements or respectively the two panel elements extend over the entire surface of the composite panel element. The composite panel element can have any shape, wherein a design as a plate or respectively as a panel is preferred. Furthermore, the composite panel element can have any thickness, preferably the composite panel element has a thickness between 25 μm and 1 mm, particularly preferably a thickness between 50 μm and 500 μm and, very particularly preferably, between 100 μm and 250 μm.

The panel elements according to the invention can, in particular, be microstructured films or plates and can be produced in different ways, for example, by UV embossing, hot stamping, injection molding or further methods. The panel elements are preferably formed of a highly transparent, weather-resistant and/or UV-stable material. Possible materials include, in particular, an extremely wide variety of plastics, silicones or glass, particularly preferably in conjunction with lacquer or silicone.

The composite panel element according to the invention is provided for guiding light, wherein the light is preferably guided substantially and, particularly preferably, exclusively, by total reflection at the boundary surfaces of micro-cavities arranged in the interior of the composite panel element. These micro-cavities are preferably formed and/or are arranged in the composite panel element in such a manner that a constant light guidance is carried out over the entire surface of the composite panel element.

According to the invention, both panel elements have a microstructure on an inner surface which is preferably shaped and/or arranged uniformly over the entire surface of the panel element. The inner surface is understood to be the surface of the panel element, which, in the case of the two panel elements arranged on one another to form a composite panel element, is located in each case in the interior of the composite panel element. The microstructure of the first and/or the second panel element preferably has numerous microstructure elements which are identical to one another and/or arranged periodically over the surface, each of which can have any shape and can be formed from any number of sections. The individual surfaces of the microstructure elements can be both flat or respectively uncurved, and can have a curved and/or angled profile. According to the invention, the microstructure is arranged at least on one side of each panel element, although an arrangement on both sides is also conceivable. However, the formation of microstructures on an exposed outside can also be undesirable, since there is a risk of scratching or clogging of the microstructures, for example, in the outside region of window glass. In addition, such a microstructured, outer surface can only be cleaned to a limited extent, which is why a coating or cover is preferred. In contrast, the micro-structures inside the composite panel element are protected against damage and, in particular, against mechanical effects.

The microstructure can be formed both from elevations and from depressions. The microstructure is particularly preferably formed along at least one spatial direction, in particular, preferably along at least one direction of the surface of the composite panel element, from depressions and elevations and, particularly preferably, from an alternating arrangement of depressions and elevations.

According to the invention, the microstructures are formed and arranged on the inner surface of both panel elements in such a manner that two panel elements can be brought together with the inner surfaces facing one another, wherein the two microstructures are then arranged inside one another. The panel elements are arranged, in particular, in such a manner that elevations of the first microstructure engage in depressions of the second microstructure and/or elevations of the second microstructure engage in depressions of the first microstructure. It is particularly preferred that an elevation of the first panel element is in each case arranged in a depression of the second panel element and, in each case, adjacent thereto, a depression of the first panel element is arranged in an elevation of the second panel element.

In addition, according to the invention, micro-cavities for guiding light are formed by the microstructures of two panel elements engaging with one another. The formation of the micro-cavities, which are very suitable for guiding light, in the form of remaining intermediate spaces during the engaging of the microstructures with one another advantageously allows the micro-cavities to be formed and arranged very exactly, even with small dimensions. Especially the formation of narrow, elongated micro-cavities and micro-cavities which are arranged at a relatively large angle to the surface, i.e., correspondingly smaller angle to the surface normal, can be easily attained by the microstructures engaging with one another, and is advantageous for guiding light.

The micro-cavities can in principle have any shape, any arrangement and any size. In addition, not all of the micro-cavities of the composite panel element have to be formed identically to one another, although this is, however, preferred. Alternatively, an alternating arrangement of two mutually different micro-cavities is also preferred.

Inasmuch as dimensions of the micro-cavities, in particular the length, the width or the height, are referred to, this is to be understood in terms of a surface formed vertically by the panel elements, i.e., the films or plates. The depth of the micro-cavities then relates to the dimension in the direction of the surface normal. This reference is selected for better understanding and is not to be understood in a limiting sense, i.e., the composite panel element can of course also be utilized in a different orientation.

The micro-cavities and, in particular, micro-lamellae can in principle be arranged, with a free design of the microstructures, in an extremely wide variety of ways in relation to the surface of the panel elements: vertically, obliquely, curved, with a obliquity or curvature that is variable over the surface, with different thickness and/or varying thickness, etc. The micro-lamellae can also be arranged horizontally or vertically, at any desired angle and/or in a curved manner in the plane of the panel elements.

In general, it is, however, preferred that the micro-cavities have an elongated shape and are, in particular, formed as micro-lamellae or respectively as micro-gaps, wherein an average depth of the micro-cavities is particularly preferably more than 2 times, very particularly preferably more than 5 times and, in particular, preferably more than 10 times an average height of the micro-cavities. Furthermore, the micro-cavities can extend in width over the entire surface or sections hereof. For example, the width of the micro-cavities can be at least 1 mm, preferably at least 1 cm, particularly preferably at least 5 cm and, very particularly preferably, at least 10 cm. Finally, it is preferred that the micro-cavities have, in a depth direction, an angle to the surface normal of the first and/or of the second panel element of less than 60°, particularly preferably less than 45° and, very particularly preferably, less than 30°.

The internal micro-cavities formed between the microstructures can be gas-filled, evacuated or filled with a medium that is optically less dense than the material of the panel elements or respectively of the microstructures. This results in a total reflection at the interfaces between the optically denser material of the panel elements and/or of the microstructures and the micro-cavities when light is incident at sufficiently flat angles, which total reflection is utilized for guiding light.

According to the invention, the micro-cavities are internal, i.e., the micro-cavities are embedded in the interior of the composite panel element and are preferably neither opened outwardly, nor is the interior of the micro-cavities accessible, so that the panel composite element is insensitive to contact, cleaning, scratching or other external influences.

According to the invention, the two panel elements are connected to one another on the microstructure side and, as a result, secured to one another, wherein said securing can be carried out both exclusively force-lockingly, and form-lockingly as well as force-lockingly. Furthermore, the connection of the panel elements and, in particular, of the microstructures—in addition to the form-locking and/or force-interlocking securing—lip can be carried out in a supplementary manner, for example, by bonding, ultrasonic bonding, chemical or thermal joining or in any other way.

In order to be able to achieve a force-locking fastening of the two panel elements, each of the first and second microstructures has planar-contact adhesion sections which are formed such that they correspond to one another at least in sections, preferably over the entire surface, and can thus be brought into contact in order to produce a force-locking fastening. The planar-contact adhesion sections can be both planar and curved in one or more spatial directions, wherein the adhesion sections are not, however, only provided for contact along an edge, but for a planar contact. In contrast, the corresponding latching sections are also provided for an interlocking retention and, to that end, have at least one section or a partial region having an appropriate, corresponding shape.

The composite panel elements according to the invention can, in particular, be used as composite films or composite plates having micro-lamellae, in windows and window facades, in particular, in skylights, in order to achieve the desired effect of guiding daylight into the depth of rooms. The composite panel elements can, in particular, be laminated on the inside or on the outside of window glass or be inserted into the intermediate space between insulation glazing. It is accordingly preferred that the composite panel element is formed in such a manner that it can be laminated onto a glass pane or another transparent body, in particular as a film which acts in a light-conducting manner.

In a preferred development of the composite panel element according to the invention, the internal micro-cavities extend along a depth direction of the composite panel element over a first depth region or respectively within a first depth region and the first and second panel element are secured in at least one second depth region, which advantageously means that there is no interaction, in particular of the adhesion sections, with the micro-cavities. Accordingly, it is particularly preferred that the adhesion sections and/or the latching sections are arranged completely outside of the first depth section having the micro-cavities and/or are completely arranged inside the composite panel element, wherein good protection of these regions is achieved by an arrangement completely inside the composite panel element at the same time as the ingress of dirt is prevented. The depth direction is the direction normal to a surface of the composite panel element and, consequently, typically the spatial direction having the smallest spatial extent of the composite panel element.

Although, in principle, any other desired securing in addition to the force-locking and/or form-locking fastening of the two panel elements to one another is conceivable, said fastening of the first and second panel element to one another is carried out, in a preferred development of the composite panel element according to the invention, exclusively form-lockingly and/or force-lockingly and, in particular, not in a material-fit manner. The fastening is very particularly preferably adhesive-free.

As an alternative to fastening the two panel elements to one another exclusively in a second depth region or respectively outside of the depth region of the micro-cavities, a securing in this first depth region as well can exclusively, or additionally be carried out. To this end, in an advantageous configuration of the composite panel element according to the invention, the depressions and/or elevations of the first and second microstructure each have two mutually opposite surfaces, wherein two respective first surfaces of the two panel elements arranged on one another jointly form a micro-cavity and two respective second surfaces of the two panel elements arranged on one another form the adhesion sections, in order to secure the two panel elements, in particular exclusively, force-lockingly to one another. Each depression and/or each elevation preferably has/have at least one first and one second surface which are opposite one another. The first surfaces of the two microstructures forming a micro-cavity and/or the second surfaces of the two microstructures forming an adhesion section are preferably arranged on a surface of a depression of the one microstructure and a corresponding surface of an elevation of the other microstructure. An embodiment of a composite panel element, in which the two panel elements are exclusively secured by second surfaces of the microstructures to one another, is particularly preferred.

In order to be able to achieve a particularly stabile securing of the two panel elements, a preferred development of the composite panel element according to the invention provides that, in order to form-lockingly and/or force-lockingly secure the panel elements to one another, the latching sections of the first and second panel element are in each case formed as a corresponding pair made up of a latching receptacle and a latching element. The latching receptacle is preferably arranged on a panel element and a corresponding latching element is arranged on the other panel element or respectively formed thereon.

The latching receptacle and the latching element can in principle be formed in any way and, in particular, can have any shape. The latching receptacle preferably has two inner latching surfaces pointing toward one another and preferably parallel to one another and the latching element has two outer latching surfaces pointing toward one another and preferably parallel to one another, wherein an inner latching surface and an outer latching surface are in each case in planar contact with one another. The panel elements are very particularly preferably secured by a press fit of the latching elements, wherein the distance of the two outer latching surfaces from one another is, in particular, preferably larger than the distance of the inner latching surfaces from one another. The distance of the two outer latching surfaces from one another is preferably between 0.01% and 10%, particularly preferably between 0.1% and 5% and, very particularly preferably, between 0.5% and 2% larger than the distance of the inner latching surfaces from one another. This distance exists in principle between the corresponding surfaces and/or surfaces belonging to a latching receptacle and/or to a latching element.

An embodiment of the composite panel element according to the invention, in which the two panel elements are secured to one another by latching, is likewise advantageous, wherein at least one latching nose is preferably arranged on the latching element or on the latching receptacle in order to safeguard the two panel elements against pulling apart. This can involve a detachable connection of the two panel elements or an irreversible catching which can no longer be opened without an at least partial destruction of the microstructures.

The height of the micro-cavities in the height direction of the composite panel element and the depth of the micro-cavities in the depth direction of the composite panel element must be selected such that, on the one hand, the greatest possible light guidance is achieved and, on the other hand, good optical properties of the composite panel element are, however, also preserved so that it cannot be perceived as annoying by a user. Accordingly, an advantageous embodiment of the composite panel element is preferred, in which the height of the micro-cavities is between 100 nm and 20 μm, particularly preferably between 1 μm and 10 μm and, very particularly preferably, between 3 μm and 8 μm and/or the depth is between 20 μm and 1 mm, particularly preferably between 50 μm and 500 μm and, very particularly preferably, between 100 μm and 300 μm.

A particularly advantageous development of the composite panel element according to the invention provides that the panel elements and, in particular, the entire composite panel element are completely transparent. Completely transparent means, in particular, without any cloudiness, inclusions, discolorations and/or cavities that are visible to the eye, i.e., the composite panel element or respectively the panel elements is/are not diffuse and/or is/are substantially permeable to light without any restrictions. In particular, it is preferred that the two panel elements and, very particularly preferably, consequently, also the composite panel element are formed as transparent and/or flexible films.

Multiple exemplary embodiments of a composite panel element according to the invention for guiding light are explained in greater detail below with reference to the drawings, wherein:

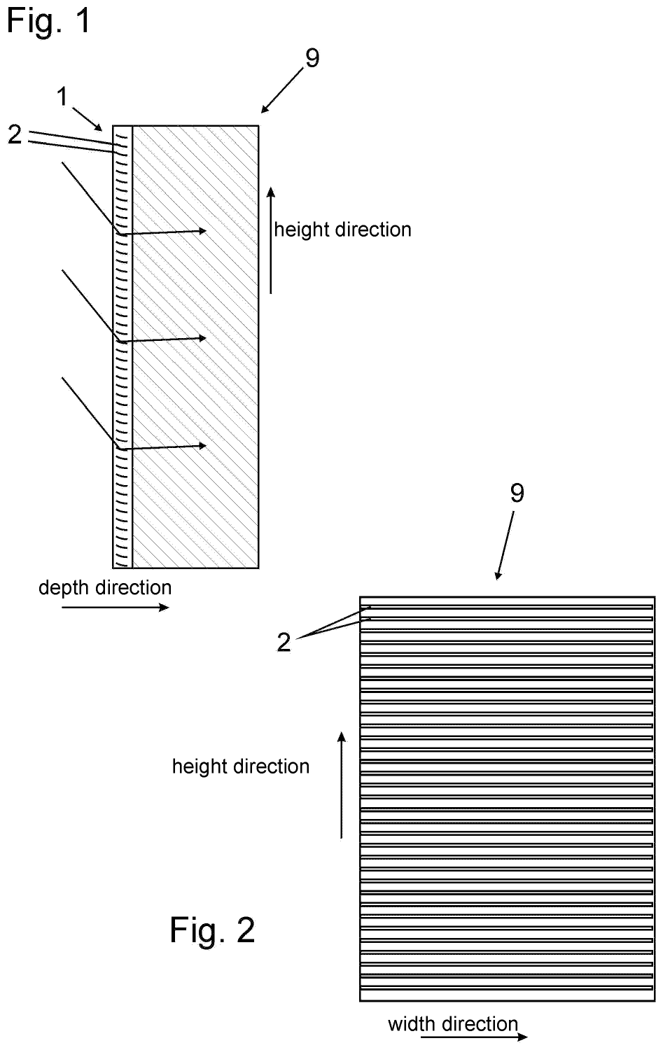

FIG. 1 shows a schematic sectional view of a window pane having a composite panel element;

FIG. 2 shows a front view of the window pane depicted in FIG. 1;

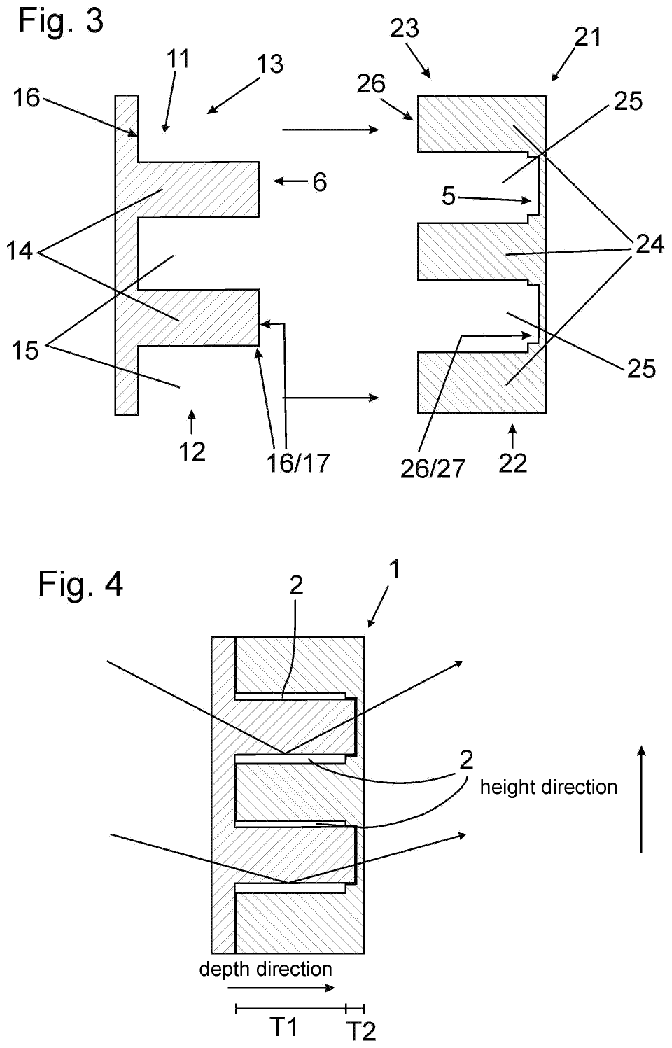

FIG. 3 shows a schematic longitudinal sectional representation of a first and of a second panel element with a microstructure according to a first embodiment;

FIG. 4 shows a schematic longitudinal sectional representation of a composite panel element composed of the panel elements according to the first embodiment;

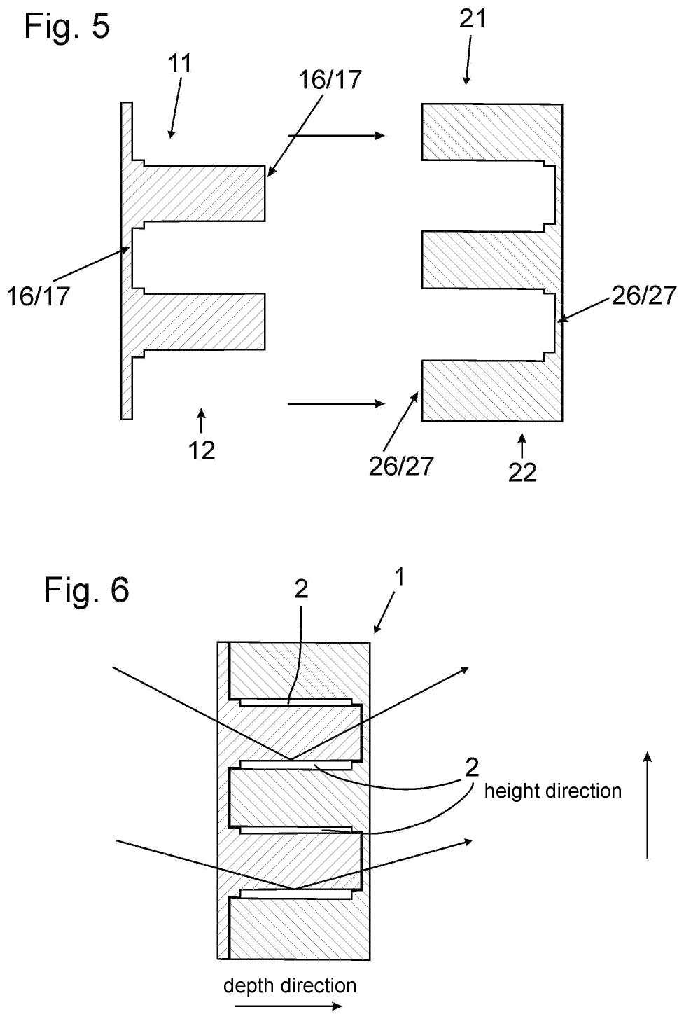

FIG. 5 shows a schematic longitudinal sectional representation of a first and of a second panel element with a microstructure according to a second embodiment;

FIG. 6 shows a schematic longitudinal sectional representation of a composite panel element composed of the panel elements according to the second embodiment;

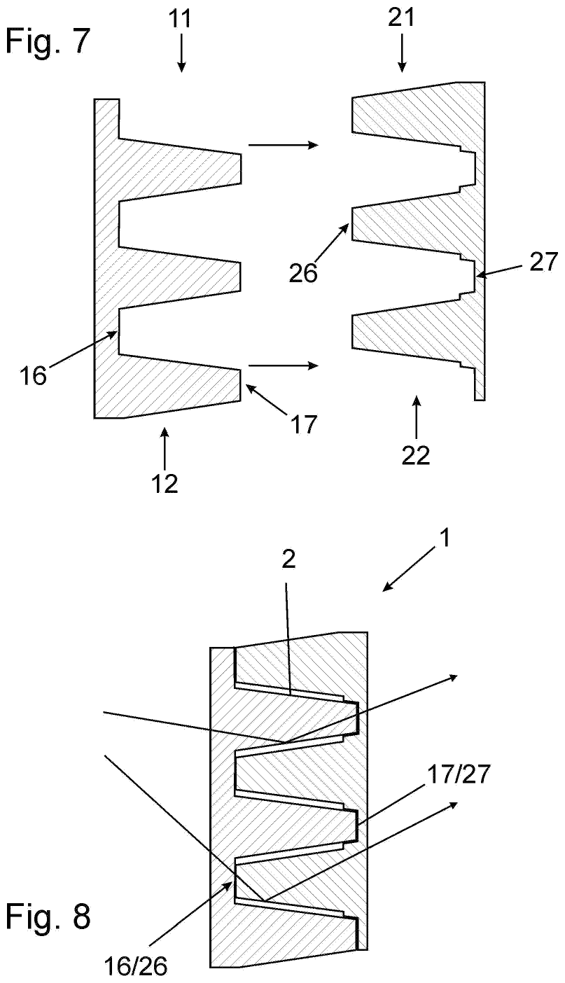

FIG. 7 shows a schematic longitudinal sectional representation of a first and of a second panel element with a microstructure according to a third embodiment;

FIG. 8 shows a schematic longitudinal sectional representation of a composite panel element composed of the panel elements according to the third embodiment;

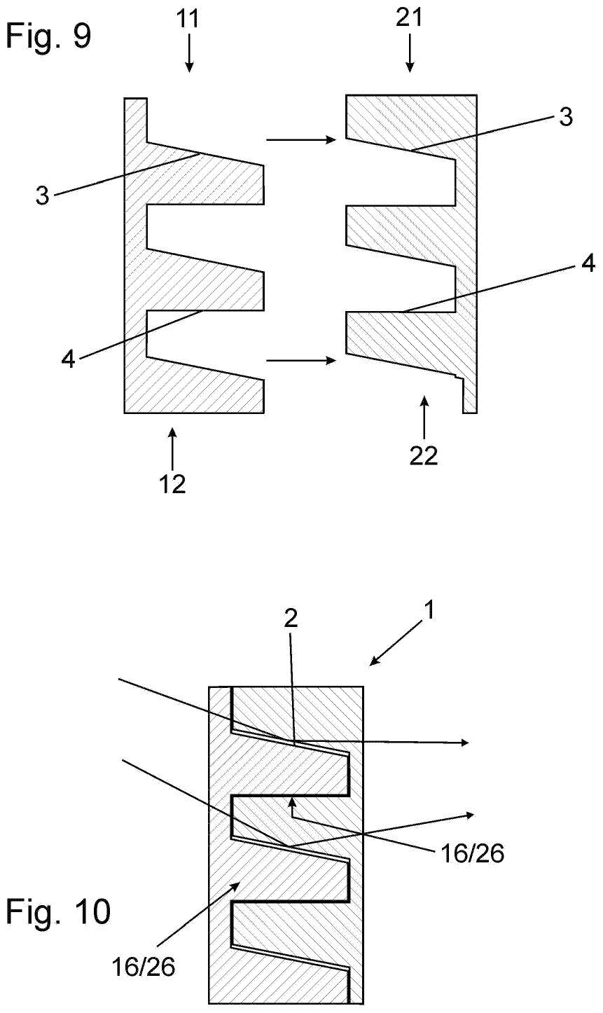

FIG. 9 shows a schematic longitudinal sectional representation of a first and of a second panel element with a microstructure according to a fourth embodiment;

FIG. 10 shows a schematic longitudinal sectional representation of a composite panel element composed of the panel elements according to the fourth embodiment;

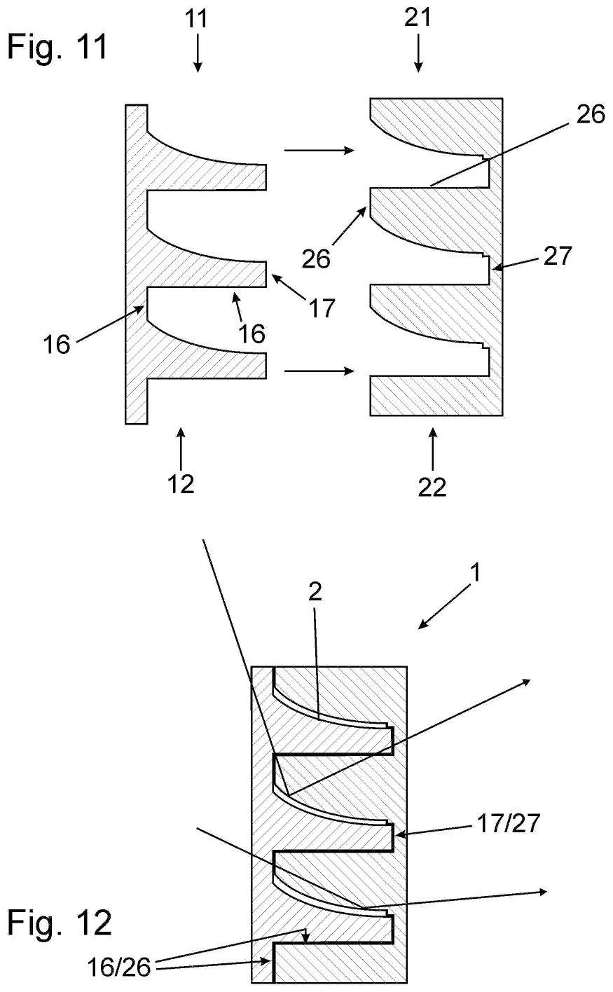

FIG. 11 shows a schematic longitudinal sectional representation of a first and of a second panel element with a microstructure according to a fifth embodiment;

FIG. 12 shows a schematic longitudinal sectional representation of a composite panel element composed of the panel elements according to the fifth embodiment;

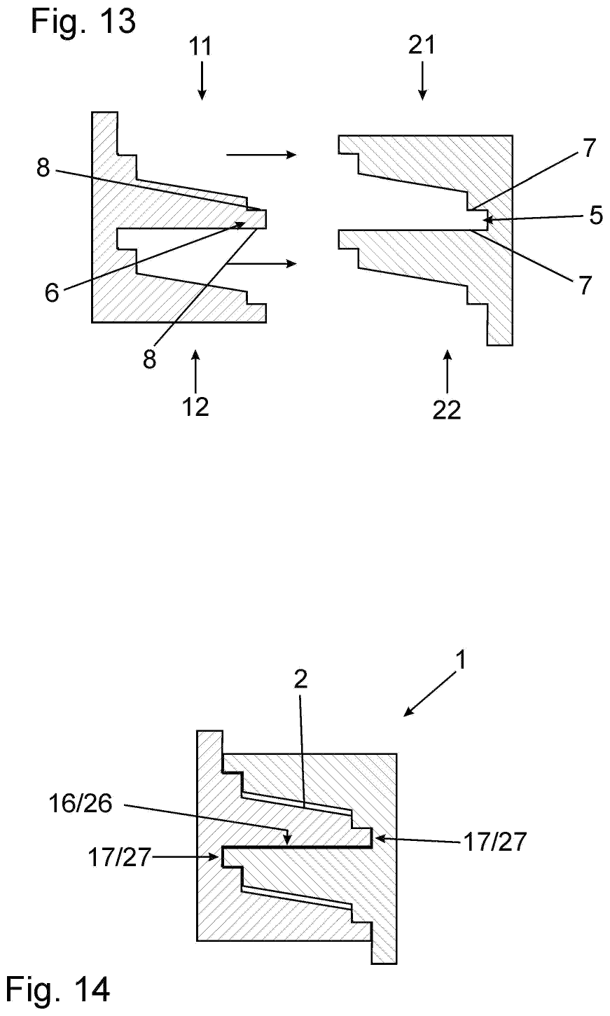

FIG. 13 shows a schematic longitudinal sectional representation of a first and of a second panel element with a microstructure according to a sixth embodiment;

FIG. 14 shows a schematic longitudinal sectional representation of a composite panel element composed of the panel elements according to the sixth embodiment;

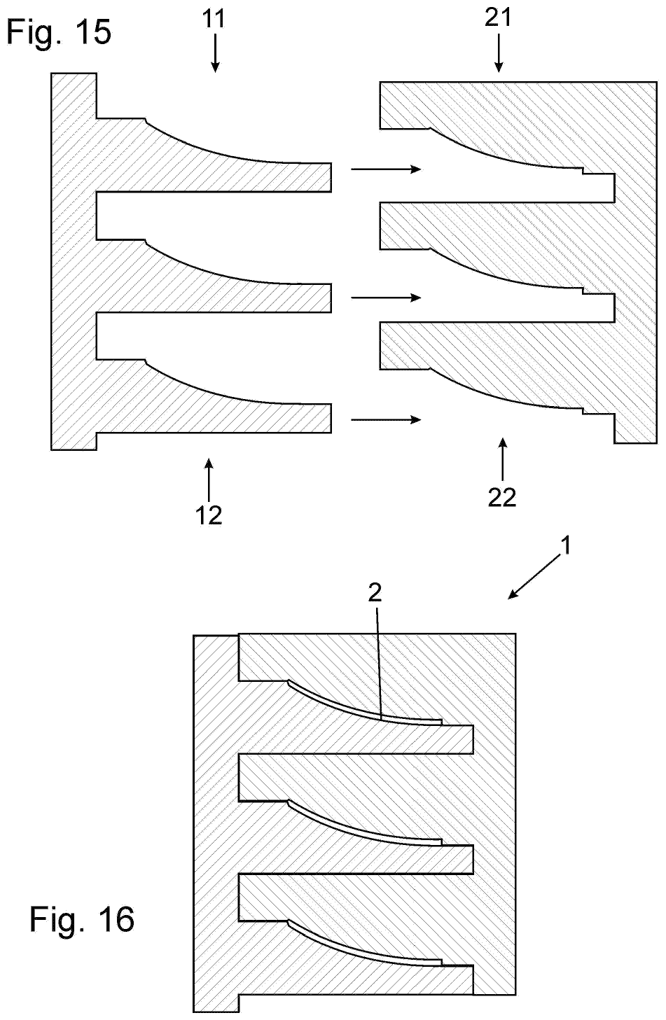

FIG. 15 shows a schematic longitudinal sectional representation of a first and of a second panel element with a microstructure according to a seventh embodiment; and

FIG. 16 shows a schematic longitudinal sectional representation of a composite panel element composed of the panel elements according to the seventh embodiment.

The various embodiments of a composite panel element 1 are each formed as a composite from two transparent panel elements 11, 21, wherein the panel elements 11, 21 are each preferably formed as films and/or plates. Furthermore, the panel elements 11, 21 each have a microstructure 12, 22 at least on one side. The two panel elements 11, 21 are connected on the microstructure side with inner surfaces 13, 23 lying one on another so that defined micro-cavities 2, in particular micro-gaps or respectively micro-lamellae, are created between the micro-structures 12, 22. The composite panel elements 1 can, in particular, be used in order to be arranged on the surface of a window pane 9 and, consequently, to achieve improved light guidance of obliquely incident light into the room (see FIG. 1).

The microstructures 12, 22 of a composite panel element 1 are intermeshed so that an elevation 14 of the first microstructure 12 is in each case positioned in a depression 25 of the second microstructure 22 and an elevation 24 of the second microstructure 22 is positioned in a depression 15 of the first microstructure 12. As a result of the intermeshing of the microstructures 12, 22, gaps can be formed as micro-cavities 2 having a very large aspect ratio (ratio of width to height) (see FIG. 2), which cannot be realized or respectively cannot be easily realized in manufacturing terms with the conventional microstructuring of surfaces.

The micro-cavities 2 created by microstructure-side connection and embedded between the microstructures 12, 22, are filled with air, as a result of which the incident light is totally reflected by the micro-cavities 2, as long as the conditions for total reflection are met. The light deflection is therefore substantially based on loss-free total reflection.

The micro-cavities 2 can be arranged horizontally or vertically, at any desired angle or in a curved manner, in the film/plate plane of the composite panel element 1. FIGS. 3-16 show, by way of example, some microstructure combinations and the cross-sectional profiles of the micro-cavities 2, in particular of micro-lamellae, that are created when the two panel elements 11, 21 are joined together. In the drawings, the depth, width and height directions are indicated for better understanding with reference to a vertical planar element.

The two microstructured inner surfaces 13, 23 of the two panel elements 11, 21 can be secured force-lockingly to one another and/or or latched in one another by means of a suitable profile geometry.

In a first embodiment shown in FIGS. 3 and 4, in the region of the depressions 15 of the first microstructure 12, the two panel elements 11, 21 are exclusively secured to one another by force-locking engagement via two planar-contact adhesion sections 16, 26 of the two microstructures 12, 22, whereas in the region of the depressions 25 of the second microstructure 22, an interlocking securing is additionally carried out, wherein a latching section 17 at the end of the elevations 14 of the first microstructure 12 comes into engagement with a corresponding latching section 27 in the interior of the depressions 25 of the second microstructure 22. The first latching section 17 is formed as a male latching element 6, whereas the second latching section 27 is formed as a female latching receptacle 5. Micro-cavities 2, which extend perpendicular to the surface of the composite panel element 1, are formed in each case between the microstructures 12, 22.

A further embodiment, shown in FIGS. 5 and 6, merely differs from the first embodiment in that in the region of the depressions 15, 25 of both microstructures 12, 22, the two panel elements 11, 21 are secured to one another in a force-locking and interlocking manner, so that the two panel elements 11, 21 have a mirror-symmetrical construction and are merely arranged, displaced in relation to one another.

A further embodiment, shown in FIGS. 7 and 8, merely differs from the first embodiment in that the micro-cavities 2 no longer run parallel to the depth direction, but run in an alternately inclined manner in the height direction. The latching can also be designed in such a manner that micro-cavities 2 are only created in each case on one side of the microstructure 12, 22, while a force-locking 3o material adhesion takes place on the other side. To that end, a slightly adhesive surface may be necessary, which can be attained, for example, by selecting a slightly adhesive material in the microstructure 12, 22 or a corresponding coating. Two first surfaces 3 of each of the two microstructures 12, 22 are in each case spaced apart and are preferably also arranged parallel to one another so that these form a micro-cavity 2, while two second surfaces 4 of the two microstructures 12, 22 are in contact over the entire surface and form an planar-contact adhesion section 16, 26 (see FIGS. 9 and 10).

An embodiment, shown in FIGS. 11 and 12, differs significantly from the previous embodiment in FIGS. 9 and 10 in that, in addition to the force-locking securing by means of adhesion sections 16, 26, an interlocking securing is also carried out by means of latching sections 17, 27. In addition, the micro-cavities 2 formed as micro-lamellae have a curved profile in the depth direction. In principle, it is also possible that the lo micro-cavities 2 do not extend over the entire depth of the depressions 15, 25, as depicted by way of example in FIGS. 15 and 16.

A latching can in particular also be achieved in that, in the region of the latching section 17, 27, the width of the latching receptacle 5 is slightly smaller than the width of the latching element 6 resulting in a press fit. To that end, the inner latching surfaces 7 of the latching receptacle 5, which are preferably parallel to one another, have a smaller distance from one another than the two outer latching surfaces 8 of the latching element 6 (see FIGS. 13 and 14).

The composite panel elements 1 formed as composite films or plates having micro-lamellae as micro-cavities 2 can be used in windows, on window panes 9 and on window facades, in particular in skylights, in order to achieve the desired effect of guiding daylight into the depth of rooms. Films can be laminated onto the inside or outside of the window glass or inserted into the intermediate space of insulation glazing. The micro-cavities 2 are embedded in the interior of the film or plate; in this respect, the film is insensitive to touch, cleaning, scratching or other external influences.

### LIST OF REFERENCE NUMERALS

1 Composite panel element

2 Micro-cavities

3 First surface

4 Second surface

5 Latching receptacle

6 Latching element

7 Inner latching surface

8 Outer latching surface

9 Window pane

11 First panel element

12 First microstructure

13 First inner surface

14 Elevations of the first microstructure

15 Depressions of the first microstructure

16 Adhesion section of the first microstructure

17 Latching section of the first microstructure

21 Second panel element

22 Second microstructure

23 Second inner surface

24 Elevations of the second microstructure

25 Depressions of the second microstructure

26 Adhesion section of the second microstructure

27 Latching section of the second microstructure

T1 First depth region

T2 Second depth region

1. A composite panel element for guiding light, having
a first panel element with a first microstructure on a first inner surface, wherein the first microstructure has elevations and/or depressions,
and a second panel element with a second microstructure on a second inner surface, wherein the second microstructure has depressions and/or elevations,
wherein the panel elements are arranged in relation to one another such that the first and the second inner surface are facing one another, and the first and second microstructure are arranged so that they engage with one another such that internal micro-cavities are formed between the microstructures, and
wherein the first and second microstructure each have respective planar-contact adhesion sections for force-lockingly securing the panel elements to one another and/or mutually corresponding latching sections for form-lockingly and/or force-lockingly securing the panel elements to one another.

2. The composite panel element according to claim 1, wherein characterized in that the internal micro-cavities extend along a depth direction of the composite panel element over a first depth region and the first and second panel element are secured in at least one second depth region.

3. The composite panel element according to claim 1, wherein the adhesion sections and/or the latching sections are arranged completely outside of the first depth section and/or completely inside the composite panel element.

4. The composite panel element according to claim 1, wherein the first and second panel element are secured to one another exclusively form-lockingly and/or force-lockingly.

5. The composite panel element according to claim 1, characterized in that the depressions and/or elevations of the first and second microstructure each have two opposite surfaces, wherein two first surfaces of the two panel elements arranged on one another in each case jointly form a micro-cavity and two second surfaces of the two panel elements arranged on one another in each case form the adhesion sections in order to secure the two panel elements force-lockingly to one another.

6. The composite panel element according to claim 1, characterized in that, in order to form-lockingly and/or force-lockingly secure the panel elements to one another, the latching sections of the first and second panel element are in each case formed as a corresponding pair made up of a latching receptacle and a latching element.

7. The composite panel element according to claim 1, characterized in that the latching receptacle has two inner latching surfaces pointing toward one another and parallel to one another and the latching element has two outer latching surfaces pointing toward one another and parallel to one another, wherein an inner latching surface and an outer latching surface are in each case in planar contact with one another.

8. The composite panel element according to claim 1, characterized in that the panel elements are secured by a press fit of the latching sections, wherein the distance of the two outer latching surfaces from one another is larger than the distance of the inner latching surfaces from one another.

9. The composite panel element according to claim 1, wherein the two panel elements are secured to one another by latching, wherein at least one latching nose is arranged on the latching element or on the latching receptacle in order to safeguard the two panel elements against pulling apart. cm 10. The composite panel element according to claim 1, wherein the composite panel element is completely transparent.

11. The composite panel element according to claim 1, wherein the two panel elements are formed as transparent and/or flexible films.

12. The composite panel element according to claim 1, wherein the micro-cavities have a height between 100 nm and 20 μm, or preferably between 1 μm and 10 μm or and, particularly preferably, between 3 μm and 8 μm.

13. The composite panel element according to claim 1, wherein the micro-cavities have a depth between 20 μm and 1 mm, or between 50 μm and 500 μm or and, particularly preferably, between 100 μm and 300 μm.

14. A window having
a window pane, and
a composite panel element according to claim 1 mounted thereon.

15. A method for producing a composite panel element (1) for guiding light, comprising
providing a first panel element with a first microstructure on a first inner surface, wherein the first microstructure comprises elevations and depressions,
providing a second panel element with a second microstructure on a second inner surface, wherein the second microstructure comprises elevations and depressions,
arranging the panel elements in relation to one another such that the first and the second inner surface are facing one another, and the first and second microstructure are arranged to engage with one another such that internal micro-cavities are formed between the microstructures,
wherein a form-locking and/or force-locking securing of the panel elements to one another is achieved by means of planar adhesion sections in each case of the first and second microstructure and/or by means of mutually corresponding latching sections of the first and second microstructure.
